(19) United States
(12) Patent Application Publication
(10) Pub. No.: US 2008/0189325 A1
(43) Pub. Date: Aug. 7, 2008

(54) Intelligent Assembly System and Method of Use

(75) Inventors: Philip C. Hanses, East Lansing, MI (US); Michael A. Drago, Novi, MI (US)

Correspondence Address: FISH & RICHARDSON P.C., P.O. BOX 1022, MINNEAPOLIS, MN, 55440-1022, US

(73) Assignee: ELECTRONIC DATA SYSTEMS CORPORATION, Plano, TX (US)

(21) Appl. No.: 11/555,141

(22) Filed: Oct. 31, 2006

(51) Int. Cl. G06F 17/30; G06F 7/06; G06F 17/00

(52) U.S. Cl. 707/104.1; 707/2; 700/1; 700/11; 700/116; 707/E17.009

(57) ABSTRACT

A manufacturing system and method for manufacturing a product include storing product-related information with the product during at least one of a time of manufacture and during the life of the part after manufacturing. The product-related information may be stored on one or more tags secured to a portion of the product and may be used to facilitate or control an aspect of manufacturing. During manufacturing, product-related information may be updated, for example, to reflect completion of a manufacturing operation. Product-related information, such as maintenance and warranty information, may also be recorded after manufacturing, such as during the service life of the product.

### TECHNICAL FIELD

This invention relates to providing product-related information during manufacturing and utilization of the information both during manufacturing and after completion of manufacturing.

### BACKGROUND

In conventional assembly process, a completed product may be a conglomeration of numerous individual parts, assemblies, and subassemblies. Additionally, the product may be assembled in a factory, and the product may be assembled or process along an assembly line. Traditionally, assembly lines entail assembling a single component or conducting a single process at a dedicated assembly station along the assembly line. Thus, a line worker repetitively performs that same operation to each product as it advances down the assembly line. Further, the assembly stations are generally arranged according to a logical progression, for example, such that a subsequently added component or subsequently performed process may only be added or performed once all previous steps have been performed. Thus, if the assembly line should ever encounter difficulty at a particular assembly station, all or a portion of the assembly line becomes idle, particularly the assembly stations following the troubled station. As a result, production essentially ceases, which incurs large costs to the manufacture not only in lost sales but also due to continuing labor costs.

Additionally, present assembly line systems are reliant upon centralized databases to store manufacturing information. For example, the centralized database may include a detailed parts list for each product to be manufactures as well as specifications associated with processes to be performed on the product or components thereof. The central database may need to be accessed at each assembly station along the assembly line to ensure that the appropriate components and processes are performed on the products. Consequently, such assembly line systems are susceptible to delays or stoppages when a problem develops with the central database. As a result, the manufacturer faces significant costs and lost profits.

Systems and techniques are described for retaining production-related information with the product or components thereof throughout manufacturing as well as the life of the part. For example, the product-related information may be stored on a tag secured to a portion of the part. The tag may be an electronically recordable tag, such as a radio frequency identification (“RFID”) tag, an optically recordable tag, a smart card, or any other suitable tag having read/write capability. Product-related information stored on the tag may be accessed at one or more times during manufacturing, for example, to identify a component to be assembled to or process to be performed upon the product. Once the manufacturing operation has been performed, the product-related information may be updated to reflect, for example, assembly of one or more components, performance-related information of the one or more components, process-related information, and an identifier of an assembler that performed an aspect of the manufacturing operation. The tag may also be updated to include product-related information stored on one or more other tags provided on other components assembled to the product. Product-related information may include an assembly or manufacturing order of the product, component part numbers or identifiers to be assembled at each step of the manufacturing process, required process settings, assembly specifications, and the like.

The tag may also be updated with post-production information, such as warranty, repair, service, or maintenance information performed on the product during the life of the product. The product-related information may be used to determine whether a component or process to be applied to the product is the specified component or process or whether the specified component or process is available by comparing an identifier stored on the tag with an identifier stored on the component or with the process. If the identifiers correspond, the component or process is applied. If the identifiers do not correspond, the correct components may be ordered/retrieved from general stores or the correct process may be applied.

Upon completion of the manufacturing process, the product-related information may be transmitted to a centralized data repository, such as a central database. The product-related information may also be transmitted to the central database on one or more occasions throughout the manufacturing process. After manufacturing, the tag containing the product-related information remains with the product throughout the life of the product and may be read and/or updated to reflect service, maintenance, repair, or other related information. The product-related information may also be utilized to collect data, such as to determine whether a manufacturing operation is flawed or incorrectly applied by reading the assembler identifier stored on the tag. Further, the product-related information may contain warranty information or may be utilized to address warranty-related problems associated with the product.

In one general aspect, retaining production-related information with the product or components thereof throughout both manufacturing as well as the life of the part may be implemented by storing product-related information on an unfinished product at one or more occasions during manufacturing of the product and recalling at least a portion of the product-related information after completion of the manufacturing of the product. Implementations may include one or more of the following features. Recalling at least a portion of the product-related information during manufacturing of the product may be utilized to control an aspect of the manufacturing process. Further, recalling at least a portion of the product-related information during manufacturing of the product to control the manufacturing of the product may include identifying a component identifier corresponding to a component to be assembled to the product that is included with the product-related information and comparing the component identifier with an identifier of an actual component to determine whether the actual component corresponds to the identified component to be assembled. Recalling at least a portion of the product-related information during manufacturing of the product to control the manufacturing of the product may also include identifying a process to be performed on the product by utilizing the product-related information that is included with the product-related information and determining whether the process is available to be applied to the product. The production-related information may be utilized to perform more than one assembly operation or more than one process to the product at a single assembly station. The product-related information may be stored on a tag secured to a product. The tag may include a smart card having a processor and memory, a radio frequency identification tag. an optically recordable medium, or any other tag having a read/write capability. Further, storing product-related information on an unfinished product at one or more occasions during manufacturing of the product may include consolidating product/related information included with one or more components of the product on a primary tag included with the product. Product-related information may include at least one of product repair or product service information, and recalling at least a portion of the product-related information after completion of the manufacturing of the product may include reading the product-related information to facilitate at least one of repairing or maintaining the product. Product-related information may also include at least one of a manufacturing assembly order; an identifier of one or more components to be assembled to the product; an identifier of a process to be performed on the product during manufacturing; or an identifier of an assembler that participated in manufacturing the product. Various implementations may also include transmitting the product-related information to a centralized data repository during or after manufacturing of the product. Various implementation may also include recording post production-related information to the product after completion of manufacturing of the product. Post product-related information may include one of repair, maintenance, and warranty-related information.

In another general aspect, retaining production-related information with the product or components thereof throughout both manufacturing as well as the life of the part may be implemented by a machine-readable medium storing product-related information on an unfinished product at one or more occasions during manufacturing of the product and recalling at least a portion of the product-related information after completion of the manufacturing of the product. Implementations may include one or more of the following features. The machine-readable medium may also include recalling at least a portion of the product-related information during manufacturing of the product to control an aspect of the manufacturing of the product. At least a portion of the product-related information may be recalled during manufacturing of the product to control the manufacturing of the product by identifying a component identifier corresponding to a component to be assembled to the product that is included with the product-related information and comparing the component identifier with an identifier of an actual component to determine whether the actual component corresponds to the identified component to be assembled. At least a portion of the product-related information may be recalled during manufacturing of the product to control the manufacturing of the product by identifying a process to be performed on the product by utilizing the product-related information that is included with the product-related information and determining whether the process is available to be applied to the product.

Retaining production-related information with a product may be implemented by defining at least one or more assembly operations, assembly components, or processes related to a manufacturing process as product-related information; securing a tag to one of the defined assembly components; writing a least a portion of the product-related information to the first tag; reading at least a portion of the product-related information from the first tag; determining whether the assembly component with the first tag is located at a designated assembly station; determining at least one of whether a component identifier read from the first tag as part of the product-related information corresponds to a child component to be assembled at the designated assembly station or whether a process identifier read from the first tag as part of the product-related information corresponds to a process to be applied at the designated assembly station or whether a process identifier read from the first tag as part of the product-related information corresponds to a process to be applied at the designated assembly station; at least one of assembling the child component to be assembled at the designated assembly station when the component identifier corresponds to the child component or applying the process to be applied at the designated assembly station when the process identifier corresponds to the process; updating the production-related information contained on the first tag to indicate at least one of assembly of the child component or application of the process; retaining the product-related information with the product throughout the life of the product; and utilizing the product-related information retained with the product after completion of the manufacturing process.

Implementations may also include one or more of the following features. A second tag provided on the child component may be read and the product-related information contained on the first tag may be updated to include the product-related information contained on the second tag. The product-related information may be transmitted to a data repository at some point during the manufacturing process of the product. The tags may be one of a smart card having a processor and memory; a radio frequency identification tag, an optically recordable medium, or any other tag having a read/write capability.

The details of one or more implementations are set forth in the accompanying drawings and the description below. Other features will be apparent form the description and drawings, and from the claims.

### DESCRIPTION OF DRAWINGS

Other aspects of the present invention will be better understood from the following description, along with the accompanying drawings, wherein:

FIG. 1 illustrates a process for including and utilizing product-related information with a product during and after manufacturing of the product;

FIG. 2 illustrates a system for utilizing product-related information included with a product during manufacturing of the product; and

FIG. 3 illustrates a process for utilizing product-related information provided with a product.

### DETAILED DESCRIPTION

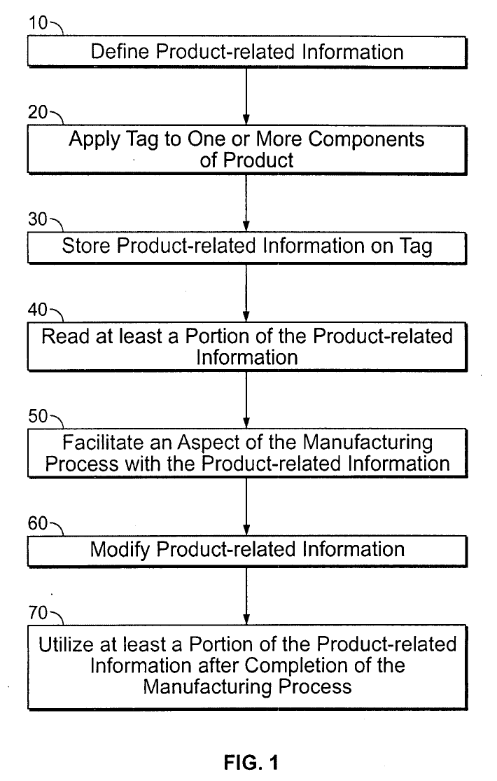

A manufacturing system and techniques for manufacturing a product are described herein. Product-related information is stored with the product during both the time of manufacture as well as during the life of the part after manufacturing. According to one implementation, a product may include many parts, assemblies, and subassemblies (referred to collectively hereinafter as “components”). Referring to FIG. 1, product-related information and/or data is defined at 10, and includes information, such as the design of the product, the components and processes to be utilized in the construction of the product, an order or progression defining the order in which components may be assembled and/or processes performed in order to produce the product, performance indicators, and results of quality control tests conducted during the production process. Product-related information may also include any product or component warranty information. Each of the components may be separately manufactured at the product's manufacturing site or manufactured separately at a supplier, for example. At the time of manufacture of each of the components, the manufacturer or supplier may add a tag, such as an RFID tag, an optical memory card, a smart card, or any other device capable of storing information, to the components, as indicated at 20. Alternatively, the tag may be integral to the component. Each tag may include a memory device for storing information and optionally a processor for executing instructions contained in the memory device. The tags are also capable of having information written to or read therefrom using methods known in the art. A tag may be attached to some components of the product, while other components of the product may not include a tag. For example, only components considered critical may have an associated tag attached thereto.

Initially, as indicated at 30, component-related information (e.g., a subset of product-related information) may be written to and stored to the tag. For example, if a component was manufactured by a supplier of the product's primary manufacturer (“manufacturer”), the supplier would write the desired information to the component's tag, such as prior to the shipment of the component to the manufacturer. Examples of component-related information may include part lot numbers, identifiers of important or critical subparts of the component, important performance and measurement data, the part number designated by the manufacturer, as well as any other desired information.

Once the components are received at the manufacturer, if shipped from a supplier, or are otherwise ready for assembly, the tags may be read, and the components may be inventoried and positioned appropriately within an assembly line. Further, additional information may be written to the tags. For example, the information written to the tag may include the manufacturing order, the part numbers of other components to be assembled to the component, processes to be performed on the product as it advances through manufacturing, or any other desired information, particularly information related to the manufacturing of the product.

Once the components are received or otherwise ready for assembly, a core component, i.e., the part or combination of parts utilized at the beginning of the assembly process, is provided at a first station of an assembly line or other desired manufacturing flow (“assembly line” will be used hereinafter to refer to any suitable manufacturing flow for convenience, though the present invention is not so limited, but, rather, is applicable to any suitable or desired manufacturing flow). As the core component advances along the assembly line, additional components are added thereto and processes may be performed thereon. The product is, therefore, incrementally produced as it advances. Thus, the product in various states of assembly may be referred to as a work-in-progress (“WIP”).

The assembly line may be arranged in any suitable manner to facilitate production of the product. The tag of the core component is red and an assembler verifies whether the component is the appropriate component and located at the appropriate station in the assembly line. An assembler may be a person who works on the assembly line, for example, to assemble various components or apply different processes to the WIP as it advances along the assembly line, or the assembler may be a robot coupled to a computer, for example. At 40 of FIG. 1, the assembler may read the contents of the tag using a suitable tag reader, such as a card reader, an RFID reader, or any other suitable reading device which is able to read the contents of the tag. In some implementations, information read from the tag instructs the assembler on how to complete at least a portion of the assembly process, as indicated at 50. That is, the information read from the tag may indicate with particularity the components to be assembled at the particular assembly station, processes to be performed on the WIP at the assembly station, the manner of assembling the components or performing the processes, and any other desired information to aid the assembler.

Once the tag is read, the assembler may verify the required manufacturing operations needed to complete assembly or a portion of the assembly of the product as well as the necessary additional components and processes to be added. The assembler may also read the information contained on any tags included with the components to be assembled to the WIP at the assembly station. This information may include, for example, the component's part identifier, the component's manufacturing date, batch identifier, manufacturing location, critical performance information, and any other information deemed necessary or desired. Further, where the assembly station is to apply a process to the product, the assembler may also read process-related information. Process-related information is also a subset of product-related information. For example, if the process includes applying a coating to all or a portion of the WIP, information such as coating composition, temperature, humidity, coating thickness, processing time, tool utilized for processing, and the like, may be recorded and subsequently written to the tag. Further, the information read from the tag may also indicate which assembly operations have previously been performed, allowing the assembler to determine whether the WIP is at the appropriate assembly station. This determination may be automatically and/or electronically made once the information from the tag is read by, for example, comparing the assembly steps that have been completed with the assembly step corresponding to the present assembly station. Alternately, the determination may be made manually by the assembler.

Once the assembler has performed the appropriate operations (e.g., confirmed that the WIP is at the correct assembly station, verified that the necessary components to be assembled are available, assembled the necessary components, and/or performed the necessary processes to the product), the assembler may update the information contained on the tag by writing information to the tag, for example, as indicated in FIG. 1 at 60. The information written to the tag may include nay of the previously-discussed information as well as any additional information deemed necessary of desirable. For example, information regarding the time and date the assembly step occurred, an identifier of the assembler performing the assembly steps, assembly data, such as bolt torque, press fit loads, tool utilized for production, and any other information may also be written to the tag.

As the WIP proceeds along the assembly line, the number of tags included therewith may grow to a large number. Moreover, one or more tags may be more accessible than others, especially once assembly of the product has been completed. Consequently, as the WIP proceeds through assembly, a single tag may be utilized as a primary tag where all of the product-related information is recorded. The primary tag may be written with all or a portion of all of the information cumulatively contained on the other tags included with the WIP of written thereto during the course of assembly. Further, more than one primary tag may be utilized, for example, when the product is large and assemblers may be provided at locations remote from each other, such as, for example, an automobile assembly line where assemblers may be provided on opposite sides of the vehicle.

after completion of the manufacturing process, the one or more tags may remain with the product. Consequently, the information contained on the tags may subsequently be accessed and used at any time for any purpose, as indicated at 70. For example, the information contained on the tag may be accessed to troubleshoot an assembly problem, determine a part number for a part included with the product, or identify assembly data relating to a particular manufacturing step, or any other reason.

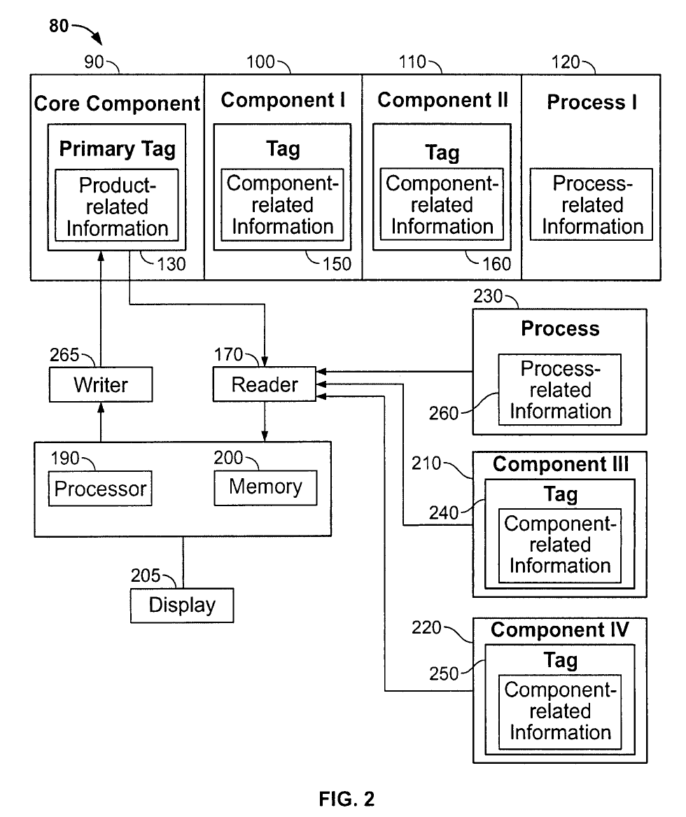

FIG. 2 is a schematic illustration of WIP as proceeds along the assembly line. As illustrated, the WIP 80 includes a core component 90, a first component 100, a second component 110, and a process 120 that has been performed on the WIP 80. The core component 90 also includes a tag 130, which acts as the primary tag. The first and second components 100, 110 also include tags 150, 160, respectively, although not all of the components assembled to form the WIP necessarily include a tag. Further, although the tag 130 of the core component 90 is indicated as being the primary tag 130, either of the tags 150, 160 may be the primary tag. Also, although the WIP is indicated as having only three components included therewith and have been subjected to any number of processes.

At an assembly station (not illustrated), the primary tag 130 of the WIP 80 is read by a device reader 170 of a type described above, for example. The product-related information is transmitted to a computer 180, having a processor 190 and a memory device 200. The memory device 200 is any suitable device for storing data, information, or instructions for execution or use by the processor 190. In the present example, only the primary tag 130 is read into the computer 180 because, for example, the information contained on the tags 150 and 160 may have already been consolidated and stored on the primary tag 130, for example, at a previous location along the assembly line. That is, all information stored on tags 150, 160 may have already been written to the primary tag 130, rendering it unnecessary to scan the tags 150, 160. Once the product-related information has been read into the computer, a production status of the WIP 80, such as, for example only, the total assembly operations of the manufacturing flow, the assembly operations previously completed, the assembly operations that are not yet completed, and the assembly operation to be completed next, may be displayed on a display screen 205, for example, or any other information display device capable of displaying information to the assembler. Once the product-related information is displayed, the assembler is able to determine whether the WIP 80 is located at the appropriate assembly station. Alternately, once the product-related information is read into the computer 180, only the next assembly operation to be performed on the WIP 80 may be display. Thus, the assembler may quickly determine if the WIP 80 is at the appropriate assembly location. In some implementations, once the product-related information is read into the computer 180, the computer 180 automatically determines whether the WIP 80 is located at the appropriate assembly station without the need for any action by the assembler.

As illustrated in FIG. 2, the WIP 80 is to receive third and fourth components 210, 220 and undergo process 230 at the assembly station. Third and fourth components 210, 220 are illustrated as having tags 240, 250, respectively, although the components to be assembled to the WIP 80 at an assembly station, such as components 210, 220, need not necessarily have a tag associated therewith. The tags 240, 250 are also read by the device reader 170 and the information stored thereon is transmitted to the computer 180 and stored, such as on the memory device 200. The components 210, 220 are then verified as being the correct components to be assembled to the WIP 80 at the particular assembly station. Verification may be performed in any manner, such as, for example, using techniques discussed above. Once verified, the assembler assembles components 210, 220 into the WIP 80.

The process 230 may also include related process information 260, which may be manually entered into the computer via an input device, such as a keyboard, mouse, keypad, or any other type of input device capable of inputting data. Alternately, the process information 260 may be inputted via a wired or wireless input or the process information 260 may be automatically transmitted to the computer 180 without any required input from the assembler. The process information 260 may be stored in the memory device 200. Further, once the process information 260 is received into the computer 180, the process 230 may be performed on the WIP 80. Alternatively, the system may first verify that the process 230 is within specifications included, for example, as part of the process information 260, prior to applying the process 230 to the WIP 80.

Once the components and/or processes have been completed at an assembly station, the information contained on the primary tag 130 is updated to include, for example, the information read from the tags 240 and 250 from the third and fourth components 210, 220, respectively, as well as the process information 260. Additionally, the information on the primary tag 130 is updated to indicate that the assembly operations conducted at the present assembly station have been completed and indicate the next assembly station along the assembly line. Other information stored on the primary tag 130 may include the information described above, the assembler identifier and any other information related to the assembly operations at the present assembly station. The information may be updated by utilizing a writer 265.

Thereafter, once any desired information has been written to the primary tag 130 or tags, the WIP 80 is advanced to the next assembly station. Similarly, at a subsequent assembly station, the primary tag is read and the assembler determines whether the WIP 80 is at the appropriate station, the operations to be performed on the WIP 80, and whether any needed components and/or processes are available for application to the WIP 80. Once all components as well as any processes are applied, any necessary information is written to the primary tag or tags, and the WIP 80 is advanced to the next station. In such a fashion, the WIP 80 proceeds along the assembly line.

The described techniques, thus, enables an assembler to perform several tasks. For example, an assembler at an assembly several processes. Because the tags included with the WIP may include the entire assembly procedures and instructions, the information included on the tags may provide all of the information needed by the assembler to accomplish these tasks. Accordingly, an assembler may be trained or programmed to perform multiple functions, which may result in a reduction in the total number of assemblers required to manufacture the product. Additionally, an assembly operation may reduce costs by having an assembler perform several assembly steps as opposed to a single assembler performing only a single step, such as assembling only a single component of performing only a single process. Further, because the assembly information is located in the tag provided on the WIP, one or more assembly operations may be quickly relocated to another assembly station should one or more assembly stations become inoperable or otherwise unavailable. As a result, the assembly line may be made further flexible and resilient, reducing or eliminating costs associated with production delays. The new assembler at a substitute assembly station need only look to the information provided on the tag to identify the last assembly operation performed and, consequently, understand the next required assembly operation. Moreover, the assembly instructions for the assembly operations may also be stored on the tag, allowing the new assembler to quickly understand how to perform the assembly operations.

Assembly lines utilizing the described techniques may be more reliable. Particularly, implementations utilizing tags that electronically store the product-related information may reduce human error because an assembler is not forced to rely on reading information provided on paper sheets, which may become soiled, damaged, or otherwise lost. Also, the described techniques reduce the risk of misreading assembly instructions or specifications where the assembler is an automated machine, such as a robot having a computer and a tag reader to read the assembly information provided on a tag. Therefore, the risk of misreading assembly/manufacturing information is significantly reduced.

Because assembly information may be provided on the tags, the techniques may be carried out without requiring a central database for storing product-related information. Thus, the information needed to assemble the product may be stored on the tag, such as the tag of the core component. Consequently, the techniques are not susceptible to problems that may develop with a centralized database—problems that would otherwise delay or idle operations of an assembly line.

A centralized database may be utilized, however. For example, once an assembly station has completed all necessary processes or assembled any necessary components, the centralized database may be updated to indicate the assembly condition of the particular WIP. Further, the central database may be updated with all of the information contained in the primary tag of the WIP to provide a complete record of the WIP. However, if a problem should occur to the problem has been corrected or until the centralized database may be postponed until the problem has been corrected or until the assembly of the product has been completed. Alternately, the centralized database may be updated only after manufacturing of the product has been completed. As a result, because the described techniques are not dependent upon a centralized database, costs associated with a centralized database may be reduced or eliminated altogether. For example, with reliance upon a centralized database, a large cost must be expended to implement fault tolerance capabilities, redundancy, and ongoing maintenance costs to maintain uptime of the centralized database. Thus, the ability to operate independently of a centralized database enables avoiding or significantly reducing the costs associated with operating the centralized database.

Once the products are completely assembled, the one or more tags, e.g., the one or more primary tags, remain with the product for the life of the product. Thus, if the product ever requires maintenance or experiences difficulty, e.g., if the product ever experiences a defect, the information provided in the tags, such as the one or more primary tags, may be utilized to identify the cause of the defect. For example, if an automobile experiences the separation of a wheel during operation, the customer or the manufacturer may read the contents of the primary tag and determine whether torque loads used to secure the wheel to the car during manufacturing wee within the design specifications. Further, data contained on the product's primary tag (or any other tag included with the product) may be quickly collected by the manufacturer, for example during warranty investigations. Consequently, the manufacturer may quickly identify a particular problem that may exist with a component or an assembly or manufacturing step of the product. Because the information is maintained in a central location that accompanies the product throughout the life of the product, information regarding the product, information that may otherwise difficult or not otherwise obtainable, is able to be efficiently and reliably collected. For example, such information may only be retained at the manufacturing facility, if at all. Thus, in order to locate manufacturing information in such circumstances, a request must be forwarded to the manufacturer and a search conducted thereafter, requiring resources of the manufacturer to be diverted.

Therefore, the described techniques may also save costs associated with collecting manufacturing information and increase the likelihood that useful market information, e.g., statistical product defect data, and the like, is not otherwise lost.

Further, post-production information, such as repair information, general maintenance information, or any other information, may also be stored on the primary tag or any tag included with the product. Thus, in some implementations, the tag is able to store a product's service and maintenance history, which may be read, accessed, or written to by a service provider, for example, whenever the product is subjected to maintenance or service. Other information may also be added to the tag. For example, repair or maintenance instructions may be stored on the tag so that a repairman or technician may quickly access needed information to effect a repair or conduct maintenance on the product. As a result, a repairman or technician is relieved of having to search through a service manual or service system in order to service or repair the product.

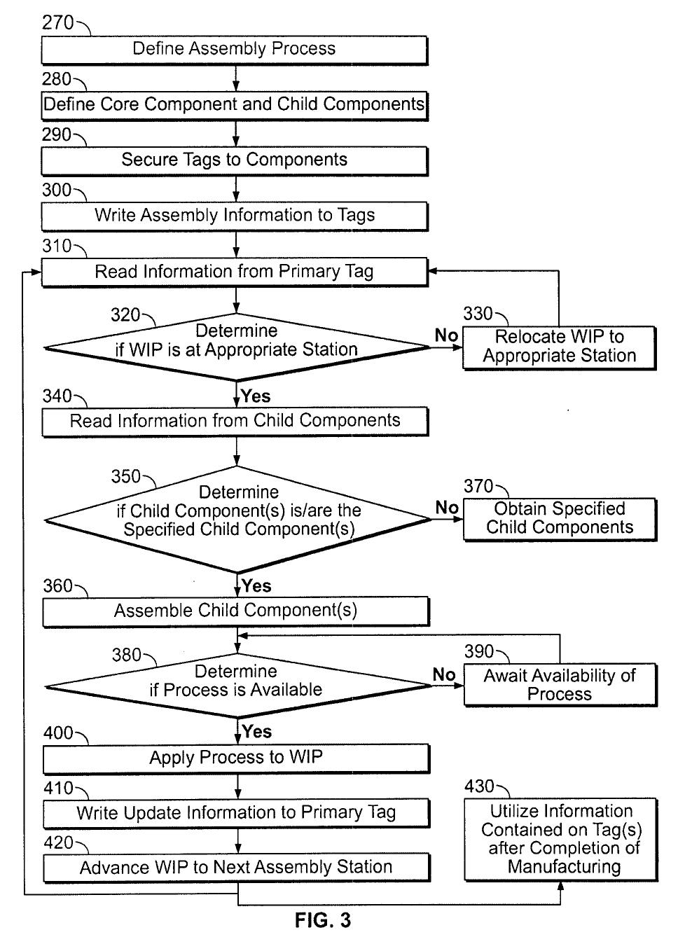

FIG. 3 illustrates an assembly process for utilizing product-related information provided with a product. At 270, the overall assembly order or process is defined. The assembly order includes, for example, the different operations required to complete the product from starting with the core component up through the completed product. The assembly order may also define the number of operations, the components to be assembled at each operation, the process to be applied and corresponding position in the assembly order, and any other information relating to the assembly of the product. At 230, the core component and other components, interchangeably referred to as child components, are designated. At 290, the associated tags are then applied to the core component and any other child components, as required of desired, and product-related information is written to the tags at 300.

Thereafter, the product-related information is read from the primary tag of the core component or WIP at 310 and is utilized to determine whether the WIP is located at the appropriate assembly station at 320. If the WIP is not located at the appropriate assembly station, the WIP is relocated to the appropriate assembly station, as indicated at 330. At 340, if the WIP is located at the appropriate station, the tags associated with one or more child components to be assembled at the assembly station are read. A determination is made at 350 as to whether the child components provided at the assembly station are the specified child components designated for assembly at the assembly station. If the components parts are the specified child components for assembly, the child components are assembled to the WIP at 360. However, if the child components are not the specified child components, the appropriate child components are obtained at 370.

The particular assembly station may also require application of a process. Accordingly, at 380, it is determined whether the process is available or whether the process characteristics are within specified ranges. For example, if a process involves forming a coating on a portion of the WIP, characteristics of the process to ensure a proper coating may be controlled, such as temperature, coating material composition, composition viscosity, color, and the like. If the process is available and/or within specified values, the process is applied to the WIP at 400. If the process is not available, the WIP awaits availability of the process at 390. Alternately, the WIP may be transferred to another location along the assembly line to conduct the specified process.

Once all of the assembly operations to be conducted at the assembly station have been completed, the information contained on the primary tag is updated at 410, such as with the information contained on the child component tags and with desired information relating to the applied process. Thereafter, at 420, the WIP is advanced to the next assembly station in the assembly order.

After assembly is complete, the product-related information may be utilized in a manner, such as those described above, at 430 because the information follows the product throughout the product's life.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodiment in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, the processor will receive instructions and data read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

A number of implementations have been described. Nevertheless, it will be understood that various modifications may be made. Accordingly, other implementations are within the scope of the following claims.

What is claimed is:

1. A process for including product-related information with a product, the process comprising:
storing product-related information on an unfinished product at one or more occasions during manufacturing of the product; and
recalling at least a portion of the product-related information after completion of the manufacturing of the product.

2. The process according to claim 1 further comprising recalling at least a portion of the product-related information during manufacturing of the product to control an aspect of the manufacturing of the product.

3. The process according to claim 2, wherein recalling at least a portion of the product-related information during manufacturing of the product to control the manufacturing of the product comprises:
identifying a component identifier corresponding to a component to be assembled to the product that is included with the product-related information; and
comparing the component identifier with an identifier of an actual component to determine whether the actual component corresponds to the identified component to be assembled.

4. The process according to claim 2, wherein recalling at least a portion of the product-related information during manufacturing of the product to control the manufacturing of the product comprises:
identifying a process to be performed on the product by utilizing the product-related information that is included with the product-related information; and
determining whether the process is available to be applied to the product.

5. The process according to claim 2 further comprising utilizing the production-related information to perform more than one assembly operation or more than one process to the product at a single assembly station.

6. The process according to claim 1, wherein the product-related information is stored on a tag secured to the product.

7. The process according to claim 6, wherein the tag comprises a smart card having a processor and a memory.

8. The process according to claim 6, wherein the tag comprises a radio frequency identification tag.

9. The process according to claim 6, wherein the tag comprises an optically recordable medium.

10. The process according to claim 6, wherein the tag is component operable to have data electronically read therefrom and have data electronically written thereto.

11. The process according to claim 1, wherein storing product-related information on an unfinished product at one or more occasions during manufacturing of the product comprises writing information electronically onto a tag secured to a portion of the product.

12. The process according to claim 1, wherein storing product-related information on an unfinished product at one or more occasions during manufacturing of the product comprises consolidating product-related information included with one or more components of the product on a primary tag included with the product.

13. The process according to claim 1, wherein the product-related information comprises at least one of product repair or product service information, and wherein recalling at least a portion of the product-related information after completion of the manufacturing of the product comprises reading the product-related information to facilitate at least one of repairing or maintaining the product.

14. The process according to claim 1, wherein product-related information comprises at least one of a manufacturing assembly order; an identifier of one or more components to be assembled to the product; and identifier of a process to be performed on the product during manufacturing; or an identifier of an assembler that participated in manufacturing the product.

15. The process according to claim 1 further comprising transmitting the product-related information to a centralized data repository during or after manufacturing of the product.

16. The process according to claim 1 further comprising recording post production-related information to the product after completion of manufacturing of the product.

17. The process according to claim 16, wherein the post production-related information is one of repair, maintenance, and warranty-related information.

18. An article comprising a machine-readable medium storing instructions for causing one ore more processors to perform operations comprising:
reading product-related information from a first tag secured to a first component of a workpiece during a manufacturing process of the workpiece;
reading product-related information from a second tag secured to a second component of the workpiece during the manufacturing process; and
storing at least a portion of the product-related information form the second tag on the first tag.

19. The article of claim 18, wherein the machine-readable medium stores instructions for causing one or more processors to perform further operations comprising transmitting the product-related information to a data repository during at least one of a time during the manufacturing process or a time after completion of the manufacturing process.

20. The article of claim 18, wherein the machine-readable medium stores instructions for causing one or more processors to perform further operations comprising utilizing the product-related information to verify that a component to be assembled during the manufacturing process is a predetermined component to be assembled.

21. The article of claim 18, wherein the machine-readable medium stores instructions for causing one or more processors to perform further operations comprising utilizing the product-relate information to verify that a process to be applied during the manufacturing process is a predetermined process to be applied.

22. A process for including product-related information with a product, the process comprising:
defining at least one or more assembly operations, assembly components, or processes related to a manufacturing process as product-related information;
securing a tag to one of the defined assembly components;
writing at least a portion of the product-related information to the first tag;
reading at least a portion of the product-related information from the first tag;
determining whether the assembly component with the first tag is located at a designated assembly station;
determining at least one of whether a component identifier read from the first tag as part of the product-related information corresponds to a child component to be assembled at the designated assembly station or whether a process identifier read from the first tag as part of the product-related information corresponds to a process to be applied at the designated assembly station;
at least one of assembling the child component to be assembled at the designated assembly station when the component identifier corresponds to the child component or applying the process to be applied at the designated assembly station when the process identifier corresponds to the process;
updating the production-related information contained on the first tag to indicate at least one of assembly of the child component or application of the process; and
retaining the product-related information with the product throughout the life of the product.

23. The process according to claim 22 further comprising:
reading a second tag provided on the child component; and
updating the product-related information contained on the first tag to include the product-related information contained on the second tag.

24. The process according to claim 22 further comprising transmitting the product-related information to a data repository at some point during the manufacturing process of the product.

25. The process according to claim 22, wherein the tag is one of a smart chard having a processor and memory, a radio frequency identification tag, an optically recordable medium, or any component operable to have data electronically read therefrom and have data electronically written thereto.
